(19) United States
(12) Patent Application Publication
(10) Pub. No.: US 2026/0197548 A1
(43) Pub. Date: Jul. 9, 2026

(54) Wireless Headphones for Hands-Free Image and Video Recording

(71) Applicant: Daniel Silguero, Pasadena, TX (US)

(72) Inventor: Daniel Silguero, Pasadena, TX (US)

(21) Appl. No.: 19/181,059

(22) Filed: Apr. 16, 2025

Related U.S. Application Data
(60) Provisional application No. 63/743,401, filed on Jan. 9, 2025.

(51) Int. Cl. H04N 23/57; H04N 5/76; H04N 23/667; H04N 23/90; H04R 1/02; H04R 1/08; H04R 1/10

(52) U.S. Cl. CPC H04N 23/57; H04N 5/76; H04N 23/667; H04N 23/90; H04R 1/028; H04R 1/08; H04R 1/1008; H04R 1/105; H04R 2201/003; H04R 2420/07

(57) ABSTRACT

The present invention is a hands-free audio-visual headphone device. The device includes a pair of over-ear or on-ear headphone ear cups connected via an adjustable arm, with embedded high-resolution cameras, directional or omnidirectional microphones, illumination sources, onboard memory storage, and a wireless communication module. The device enables users to capture images, record videos, and store or transmit multimedia content hands-free. Cameras and microphones may be actuated via touch or voice commands. A remote device, such as a smartphone or tablet, wirelessly pairs with the headphone apparatus to configure device settings, control activation, and receive captured media for playback or live streaming.

### CROSS-REFERENCE TO RELATED APPLICATION

The present application claims priority to, and the benefit of, U.S. Provisional Application No. 63/743,401, which was filed on Jan. 9, 2025, and is incorporated herein by reference in its entirety.

### FIELD OF THE INVENTION

The present invention generally relates to wearable multimedia capture devices. More specifically, the invention relates to a hands-free audio-visual recording apparatus. The apparatus includes high-definition cameras, directional microphones, and embedded lighting into the structure of over-ear or on-ear headphones, enabling users to record video, capture images, and collect audio from a natural point of view while on the move. The apparatus maintains the core functionality of wireless headphones, including Bluetooth or Wi-Fi connectivity, and adds multimedia recording capabilities without the need for handheld devices. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals frequently use smartphones, tablets, and other portable smart devices to capture and share their daily experiences through photos, videos, and audio recordings. Individuals document moments for personal or professional use during travel, social events, or outdoor adventures.

However, current methods of media capture primarily use handheld devices such as smartphones or digital cameras, which present several limitations. Capturing video or taking photos typically requires the user to hold the device in one hand, leaving only one hand free for other tasks. This makes it difficult to perform simultaneous activities such as carrying luggage, interacting with others, or navigating an environment. Additionally, attempting to record while engaged in conversation or while moving can result in poor framing, shaky footage, or entirely missed moments. Moreover, users often miss spontaneous or fleeting opportunities to record a perfect shot due to limited accessibility or obstructions that prevent quickly retrieving and using their device. Accordingly, individuals desire a hands-free solution that enables real-time audio-visual recording without requiring the use of a handheld device.

Therefore, there exists a long-felt need in the art for a hands-free audio-visual recording apparatus that enables users to capture photos, videos, and audio while engaged in other activities. There is a long-felt need for a wearable recording solution that eliminates the inconvenience of handheld devices, which often require manual operation and constant handling. Additionally, there exists a long-felt need for a device that captures the user's point of view in real-time without obstructing movement or disrupting conversations. Furthermore, there is a long-felt need in the art for an ergonomic, head-mounted device that integrates multimedia functionality such as camera, microphone, and lighting into a single wearable form. More specifically, there is a long-felt need for a system that supports voice or touch-activated control, onboard memory storage, and real-time wireless connectivity for playback, streaming, and remote configuration. Finally, there is a long-felt need in the art for a device that makes it easier to take photos and videos while performing other tasks like holding a conversation, working, and more.

The subject matter disclosed and claimed herein, in one embodiment, comprises a hands-free audio-visual recording apparatus. The apparatus includes a headphones frame having a first and second ear cup adjustably connected by a connecting arm. High-definition cameras, directional or omnidirectional microphones, and illumination sources such as LEDs are embedded within one or more locations on the headphones frame. The device further includes onboard memory for storing captured media, a power source such as a rechargeable lithium-ion battery, and a wireless communication module supporting Bluetooth or Wi-Fi. In preferred embodiments, the cameras and microphones may be activated via touch or by voice command using a wake word, and the illumination sources provide adequate lighting for low-light video and photo capture. Additionally, the apparatus may be remotely configured via a paired device to activate recording based on time, location, or user-defined triggers, improving automation and hands-free control.

In this manner, the hands-free audio-visual recording apparatus of the present invention fulfills the long-felt need for a wearable, intelligent, and seamless recording device. The system enables users to document experiences without interrupting daily activities or requiring manual device operation. The onboard memory storage, smart illumination, and remote pairing enhance convenience and usability. The apparatus enables users to record their surroundings without having to hold their phone or camera while recording video and taking photographs. The apparatus makes it much easier to take photos and videos while performing other tasks like holding a conversation, working, and more. The apparatus can be used by everyone, including vloggers, influencers, and content creators. The apparatus is also useful for professionals who need to document activities or tasks (i.e., mechanics, medical staff, researchers) while performing those tasks with both hands.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hands-free audio-visual recording apparatus. The hands-free audio-visual recording apparatus comprises a headphones frame comprising a first headphone ear cup and a second headphone ear cup, an adjustable connecting arm couples the first headphone ear cup and the second headphone ear cup, at least one camera is embedded in at least one of the first headphone ear cup, the second headphone ear cup, or the adjustable connecting arm, the at least one camera is configured to capture images or record video from a point of view of a wearer, one or more microphones are integrated within the headphones frame and are configured to capture ambient audio, conversations, or environmental (i.e., ambient) sounds. An illumination source is embedded adjacent to the camera for providing lighting during capture operations, and an onboard memory storage module is configured to locally store data captured by one or more cameras and one or more microphones.

In another aspect, a hands-free audio-visual recording apparatus is disclosed. The hands-free audio-visual recording apparatus includes a headphones frame including at least one ear cup, a camera is embedded in the ear cup, a microphone is integrated into the headphones frame, and a wireless communication interface transmits data from the camera and microphone to an external device.

In another embodiment, a wearable audio-visual recording system is disclosed. The wearable audio-visual recording system includes a set of wireless headphones including a first ear cup and a second ear cup connected via an adjustable arm, a pair of forward-facing cameras are respectively embedded in the outer surfaces of the first ear cup and the second ear cup, a pair of directional microphones are positioned adjacent to the cameras, a set of light-emitting diodes (LEDs) are disposed adjacent to the cameras and configured to illuminate a field of view, a storage component is configured to store timestamped multimedia files locally, and a battery is configured to supply power to the cameras, microphones, and LEDs.

In one embodiment, a method for hands-free audio-visual recording using a wireless headphone device is disclosed. The method includes the steps of receiving a touch input or voice command at a headphones frame, activating one or more cameras embedded in the headphones frame to capture video or images, activating one or more microphones to capture audio data, storing the captured video, images, and audio data locally on an onboard memory storage medium, transmitting the captured data to a paired remote device via a wireless communication module, and enabling the remote device to configure, activate, or deactivate the cameras and microphones based on user input.

In yet another aspect, a system for hands-free audio-visual recording and remote interaction is disclosed. The system includes a hands-free audio-visual recording apparatus comprising a headphones frame comprising a first headphone ear cup and a second headphone ear cup adjustably connected by a connecting arm, at least one camera embedded in the headphones frame and configured to capture images or video of surroundings from a point of view of a wearer, at least one microphone integrated within the headphones frame and configured to capture ambient audio, at least one illumination source configured to provide lighting during image or video capture, an onboard memory storage module configured to locally store audio-visual content captured by the at least one camera and the at least one microphone, a wireless communication module configured to transmit data to and receive data from a remote device. The remote device comprises a user interface configured to enable a user to remotely activate, deactivate, and configure the hands-free audio-visual recording apparatus, wherein the remote device is further configured to stream live video captured by the at least one camera and to configure operational parameters of the hands-free audio-visual recording apparatus based on geolocation, time, or user preferences.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of hands-free audio-visual recording apparatus of the present invention in accordance with the disclosed structure;

FIG. 2 illustrates a side view of the hands-free audio-visual recording apparatus of the present invention showing another position of the cameras in accordance with the disclosed structure;

FIG. 3 illustrates a block diagram showing internal electronic components of the hands-free audio-visual recording apparatus of the present invention in accordance with the disclosed structure;

FIG. 4 illustrates a schematic view of the connection of the hands-free audio-visual recording apparatus with a remote device in accordance with one embodiment of the present invention; and

FIG. 5 illustrates a perspective view showing the hands-free audio-visual recording apparatus in use for recording videos of surroundings of the wearer in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a hands-free audio-visual recording apparatus that enables users to capture photos, videos, and audio while engaged in other activities. There is a long-felt need for a wearable recording solution that eliminates the inconvenience of handheld devices, which often require manual operation and constant handling. Additionally, there exists a long-felt need for a device that captures the user's point of view in real-time without obstructing movement or disrupting conversations. Furthermore, there is a long-felt need in the art for an ergonomic, head-mounted device that integrates multimedia functionality such as camera, microphone, and lighting into a single wearable form. More specifically, there is a long-felt need for a system that supports voice or touch-activated control, onboard memory storage, and real-time wireless connectivity for playback, streaming, and remote configuration. Finally, there is a long-felt need in the art for a device that makes it easier to take photos and videos while performing other tasks like holding a conversation, working with both hands, and more.

The present invention, in one exemplary embodiment, is a system for hands-free audio-visual recording and remote interaction. The system includes a hands-free audio-visual recording apparatus comprising a headphones frame comprising a first headphone ear cup and a second headphone ear cup, at least one camera embedded in the headphones frame and configured to capture images or video of surroundings from a point of view of a wearer, at least one microphone integrated within the headphones frame and configured to capture ambient audio, at least one illumination source configured to provide lighting during image or video capture, an onboard memory storage module configured to locally store audio-visual content captured by the at least one camera and the at least one microphone, a wireless communication module configured to transmit data to and receive data from a remote device. The remote device comprises a user interface configured to enable a user to remotely activate, deactivate, and configure the hands-free audio-visual recording apparatus. A user may listen to music without interrupting recording auto and video of the surrounding. It is intended that the device will include 360 cameras.

Reference will now be made in detail to the present preferred embodiments of the invention, examples of which are illustrated in the accompanying drawings. Wherever possible, the same reference numerals are used in the drawings and the description to refer to the same or like parts.

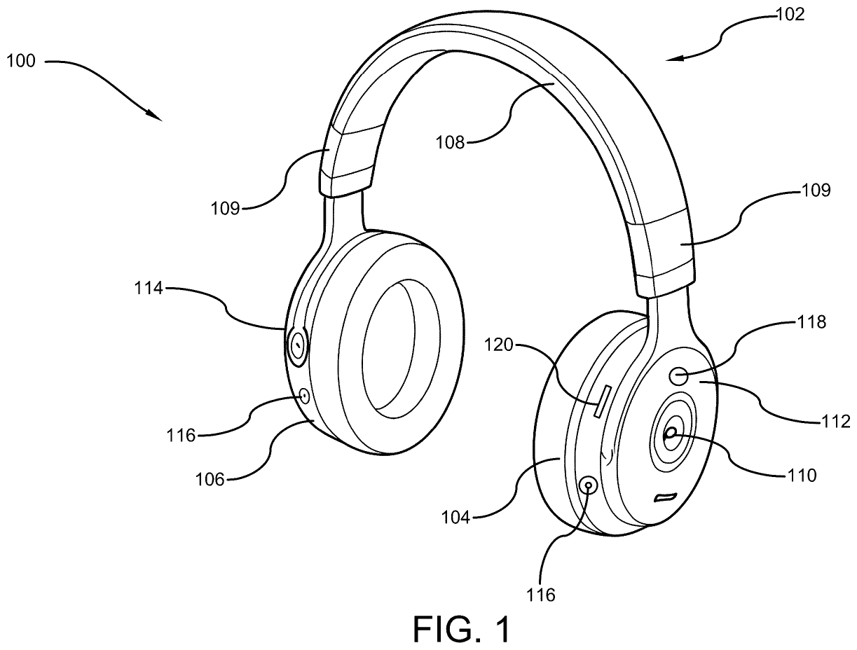

Referring initially to the drawings, FIG. 1 illustrates a perspective view of hands-free audio-visual recording apparatus of the present invention in accordance with the disclosed structure. The hands-free audio-visual recording apparatus 100 of the present invention is an innovative set of wireless headphones that enable users to capture images, record videos, and store or stream audio-visual content hands-free. More specifically, the hands-free audio-visual recording apparatus 100 includes a headphones frame 102, which comprises a first over-ear or on-ear wireless headphone ear cup 104 and a second over-ear or on-ear wireless headphone ear cup 106. The headphone ear cups 104, 106 are adjustably connected using an adjustable connecting arm 108 configured to be adjusted using the adjusting clamps 109. The frame 102 is ergonomically designed for extended use and can be adjusted to fit different users.

The hands-free audio-visual recording apparatus 100 includes one or more cameras 110 for capturing images and video of the surroundings of the wearer of the hands-free audio-visual recording apparatus 100 without requiring the wearer to hold their phone or camera in hand. In one embodiment, each of the cameras is embedded into the front-facing outer surface 112, 114 of the headphone ear cups 104, 106. In other embodiments, the cameras 110 can be embedded into the connecting arm 108 as illustrated later in the disclosure. Each camera is preferably a miniature wide-angle HD or 4K digital camera and may have resolution up to 12 MP still image. The cameras may have a plurality of recording modes, including, but not limited to, manual capture, burst mode, continuous video, and voice-triggered capture.

One or more directional or omnidirectional microphones 116 are integrated within the hands-free audio-visual recording apparatus 100 for high-fidelity audio capture and are useful for both recording environmental (i.e., ambient) sounds and enabling voice commands. The microphones 116, along with the cameras 110, help the wearer to record the surrounding events. Each microphone of the plurality of microphones 116 is preferably an electret condenser or MEMS microphone and may support Mono, stereo, or spatial channels. Each microphone supports active noise suppression for filtering out background sounds. Preferably, the microphones 116 are positioned near the front-facing edges of the ear cups 104, 106 for efficiently capturing ambient audio, conversations, narration, or environmental (i.e., ambient) sounds.

For providing adequate lighting for the cameras 110, illumination sources such as LEDs 118 are embedded in the hands-free audio-visual recording apparatus 100. The LEDs 118 provide adequate lighting in low-light conditions for photo and video capture. An onboard memory storage 120, such as microSD card slot or any other memory, is integrated in the hands-free audio-visual recording apparatus 100 for locally storing the data captured by the cameras 110 and the microphones 116. The onboard memory storage 120 can range from about 8 GB to about 64 GB, and the stored media is timestamped.

In the preferred embodiment, the cameras 110, the microphones 116, and the LEDs 118 are touch-sensitive and can be activated using touch. In some embodiments, a voice command, such as using a wake word, can be used for activating the cameras 110, microphones 116, and the LEDs 118.

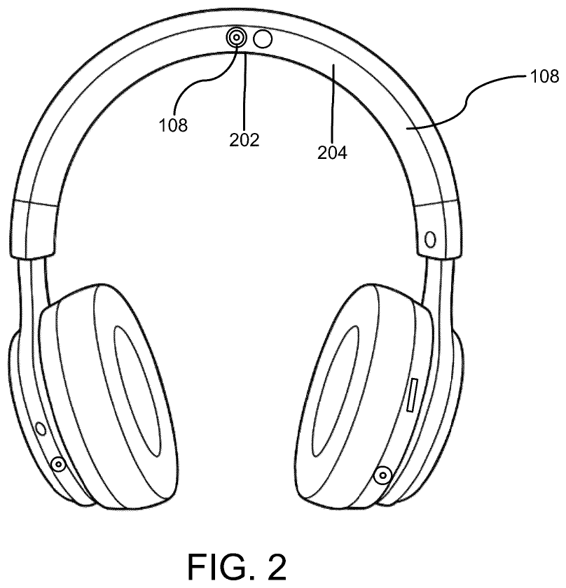

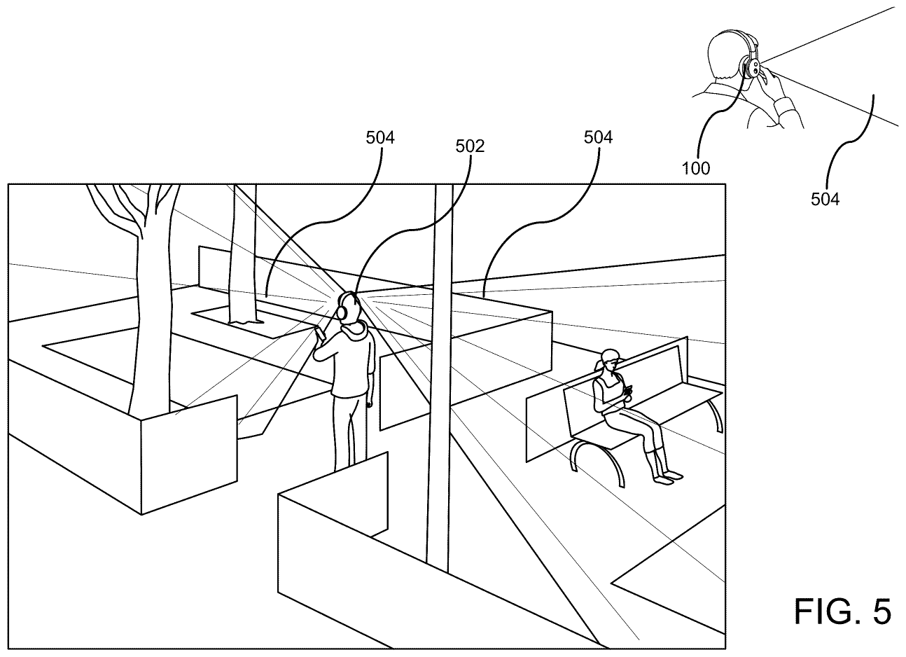

FIG. 2 illustrates a side view of the hands-free audio-visual recording apparatus of the present invention showing another position of the cameras in accordance with the disclosed structure. In the present embodiment, the camera 116 is embedded at the center 202 of the first side surface 204 of the central connecting arm 108 of the hands-free audio-visual recording apparatus 100. It should be understood that another similar camera 116 is embedded at the center of the opposite side surface of the connecting arm 108 and is not shown in the present side view. The cameras on both sides mimic the wearer's front and rear points of view (FIG. 5) and assists with effective capturing of surroundings. The LEDs 118 are also positioned adjacent to the corresponding cameras for providing adequate lighting.

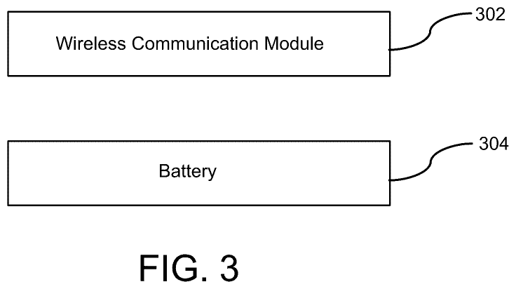

FIG. 3 illustrates a block diagram showing internal electronic components of the hands-free audio-visual recording apparatus of the present invention in accordance with the disclosed structure. The hands-free audio-visual recording apparatus 100 includes a wireless communication module 302, which can be a Bluetooth and/or Wi-Fi chipset for pairing and data transfer to smartphones, tablets, or cloud storage. The module 302 also enables remote activation of the cameras 110 and microphones 116 of the hands-free audio-visual recording apparatus 100. A rechargeable lithium-ion battery 304 is included in the frame 102 for providing electric power to the cameras 110, microphones 116, and LEDs 118 of the hands-free audio-visual recording apparatus 100.

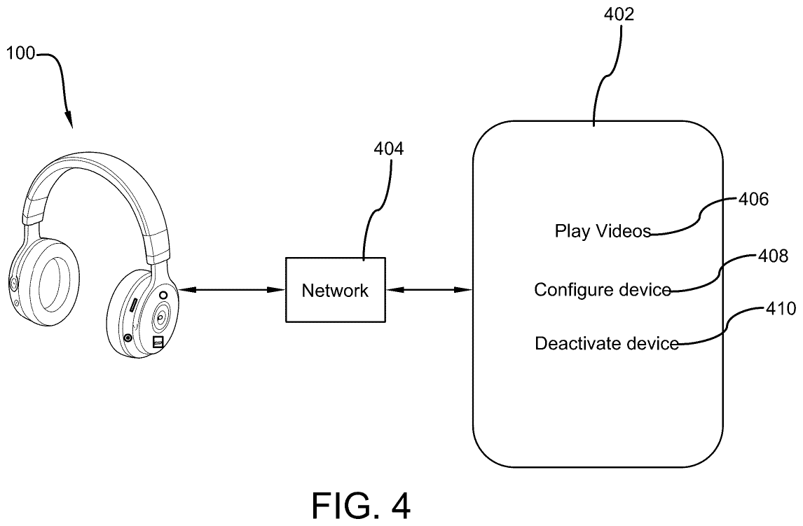

FIG. 4 illustrates a schematic view of the connection of the hands-free audio-visual recording apparatus with a remote device in accordance with one embodiment of the present invention. As illustrated, the hands-free audio-visual recording apparatus 100 can be coupled to a remote device 402 using a wireless communication channel 404. The remote device 402 can be a specialized device or a smartphone having an application compatible with the hands-free audio-visual recording apparatus 100. The remote device 402 provides a “Play Video” option 406 for enabling users to play the videos captured by the hands-free audio-visual recording apparatus 100. The users may select one or more videos along with the timestamps to replay. The users can also view real-time streaming of the videos captured by the cameras 110 of the hands-free audio-visual recording apparatus 100.

A “Configure device” option 408 enables the users to configure the hands-free audio-visual recording apparatus 100 remotely. Various parameters such as automatic activation of the hands-free audio-visual recording apparatus 100 on entering a geolocation or at a specific time, can be configured using the option 408. The hands-free audio-visual recording apparatus 100 can also be deactivated or activated remotely using the “Deactivate device” option 410.

The cameras 110 can detect objects, faces, or environments during capture and may automatically send a notification to the remote device in case any dangerous weapon is detected. The hands-free audio-visual recording apparatus 100 can also stitch views from different cameras to create a 360° panoramic capture.

FIG. 5 illustrates a perspective view showing the hands-free audio-visual recording apparatus in use for recording videos of surroundings of the wearer in accordance with the disclosed structure. As illustrated, the cameras 116 of the hands-free audio-visual recording apparatus 100 in activated mode captures the video of the surroundings of the wearer 502. Each camera can have a field of view 504 in the range from about 120 degrees to about 170 degrees. Based on preferences of the users, the cameras can be strategically embedded in different positions and orientations in the hands-free audio-visual recording apparatus 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “hands-free audio-visual recording apparatus”, “wearable audio-visual recording system”, and “wireless headphone device” are interchangeable and refer to the hands-free audio-visual recording apparatus 100 of the present invention.

Notwithstanding the foregoing, the hands-free audio-visual recording apparatus 100 of the present invention can be of any suitable configuration as is known in the art without affecting the overall concept of the invention, provided that it accomplishes the above-stated objectives. One of ordinary skill in the art will appreciate that the hands-free audio-visual recording apparatus 100, as shown in the FIGS. are for illustrative purposes only, and that many other configurations of the hands-free audio-visual recording apparatus 100 are well within the scope of the present disclosure. Although the dimensions of the hands-free audio-visual recording apparatus 100 are important design parameters for user convenience, the hands-free audio-visual recording apparatus 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hands-free audio-visual recording apparatus comprising:
a hands-free audio-visual recording device including a wireless headphones having a headphones frame, a first headphone ear cup, a second headphone ear cup, at least one camera, and a microphone;
wherein said headphones frame having an adjustable connecting arm between said first headphone ear cup and said second headphone ear cup;
wherein said at least one camera captures ambient images and records videos; and
further wherein said microphone captures ambient audio.

2. The hands-free audio-visual recording apparatus of claim 1, wherein said at least one camera embedded into said connecting arm.

3. The hands-free audio-visual recording apparatus of claim 1 further comprising another camera, wherein said at least one camera embedded into a front-facing outer surface of said first headphone ear cup and said another camera embedded into a front-facing outer surface of said second headphone ear cup.

4. The hands-free audio-visual recording apparatus of claim 3, wherein each of said at least one camera and said another camera selected from the group consisting of a wide-angle HD camera and a 4K digital camera.

5. The hands-free audio-visual recording apparatus of claim 4, wherein each of said at least one camera and said another camera having a recording mode selected from the group consisting of a manual capture mode, a burst mode, a continuous video mode, and a voice-triggered capture mode.

6. The hands-free audio-visual recording apparatus of claim 5, wherein said microphone is a directional microphone.

7. The hands-free audio-visual recording apparatus of claim 6, wherein said microphone is an omnidirectional microphone.

8. The hands-free audio-visual recording apparatus of claim 7, wherein said microphone captures ambient audio selected from the group consisting of a voice command, a conversation, a narration, and an environmental sound.

9. The hands-free audio-visual recording apparatus of claim 8, wherein said microphone is selected from the group consisting of an electret condenser microphone and a MEMS microphone.

10. The hands-free audio-visual recording apparatus of claim 9, wherein said wireless headphones having an embedded LED light.

11. The hands-free audio-visual recording apparatus of claim 10, wherein said wireless headphones having an onboard memory storage, and further wherein said onboard memory storage having a microSD card slot.

12. The hands-free audio-visual recording apparatus of claim 11, wherein said at least one camera, said another camera, said microphone, and said LED light are touch-sensitive actuated.

13. The hands-free audio-visual recording apparatus of claim 11, wherein said at least one camera, said another camera, said microphone, and said LED light are voice actuated.

14. The hands-free audio-visual recording apparatus of claim 11, wherein said at least one camera embedded into a front-facing outer surface of said connecting arm.

15. The hands-free audio-visual recording apparatus of claim 14 further comprising another camera, wherein said another camera embedded into a rear-facing outer surface of said connecting arm.

16. A hands-free audio-visual recording apparatus comprising:
a hands-free audio-visual recording device including a wireless headphones having a headphones frame, a first headphone ear cup, a second headphone ear cup, a first camera, a second camera, and a microphone;
wherein said headphones frame having an adjustable connecting arm between said first headphone ear cup and said second headphone ear cup;
wherein said first camera and said second camera capture ambient images and records videos;
wherein said microphone captures ambient audio;
wherein said first camera embedded into a front-facing outer surface of said connecting arm;
wherein said second camera embedded into a rear-facing outer surface of said connecting arm; and
further wherein each of said first camera and said second camera having a recording mode selected from the group consisting of a manual capture mode, a burst mode, a continuous video mode, and a voice-triggered capture mode.

17. The hands-free audio-visual recording apparatus of claim 16, wherein said microphone captures ambient audio selected from the group consisting of a voice command, a conversation, a narration, and an environmental sound.

18. The hands-free audio-visual recording apparatus of claim 17, wherein said wireless headphones having an embedded LED light.

19. A hands-free audio-visual recording apparatus comprising:
a hands-free audio-visual recording device including a wireless headphones having a headphones frame, a first headphone ear cup, a second headphone ear cup, a first camera, a second camera, an LED light, and a microphone;
wherein said headphones frame having an adjustable connecting arm between said first headphone ear cup and said second headphone ear cup;
wherein said first camera and said second camera capture ambient images and records videos;
wherein said microphone captures ambient audio;
wherein said first camera embedded into a front-facing outer surface of said connecting arm;
wherein said second camera embedded into a rear-facing outer surface of said connecting arm;
wherein each of said first camera and said second camera having a recording mode selected from the group consisting of a manual capture mode, a burst mode, a continuous video mode, and a voice-triggered capture mode; and
further wherein said first camera, said second camera, said microphone, and said LED light are voice actuated.

20. The hands-free audio-visual recording apparatus of claim 19, wherein said wireless headphones having a wireless communication channel for coupling with a remote device.
